(19) United States
(12) Patent Application Publication
(10) Pub. No.: US 2025/0028119 A1
(43) Pub. Date: Jan. 23, 2025

(54) OPTICAL COUPLING CIRCUIT DEVICE

(71) Applicant: KEIO UNIVERSITY, Tokyo (JP)

(72) Inventors: Hiroyuki TSUDA, Kanagawa (JP); Daisuke NAKAGAWA, Kanagawa (JP)

(21) Appl. No.: 18/717,666

(22) PCT Filed: Nov. 29, 2022
(86) PCT No.: PCT/JP2022/043972

§ 371 Date: Jun. 7, 2024

(30) Foreign Application Priority Data
Dec. 8, 2021 (JP) 2021-199560

(51) Int. Cl. G02B 6/30

(52) U.S. Cl. CPC G02B 6/305

(57) ABSTRACT

An optical coupling circuit device includes an optical circuit board including an optical circuit; an optical fiber coupled to the board; and an optical coupling waveguide formed in the board and configured to optically couple the fiber and the optical circuit. The fiber includes a cut surface obliquely cut at 3° to 30° to an optical axis of the fiber, and is coupled to the board at the cut surface. With a direction normal to the board being z-direction, a plane orthogonal to z-direction being xy-plane, a direction in which an optical axis of the optical coupling waveguide extends toward the fiber in xy-plane being x-direction, and a direction orthogonal to x-direction and z-direction being y-direction, second position of a leading end of a core end surface exposed at the cut surface is offset from first position of a coupling end of the optical coupling waveguide in x-direction and z-direction.

### TECHNICAL FIELD

The present disclosure relates to an optical coupling circuit device, and in particular, to an optical coupling circuit device including a coupling between an optical waveguide formed on an optical circuit board and an optical fiber.

### BACKGROUND ART

When an optical waveguide, such as a silicon wire waveguide, formed on a board and an optical fiber are optically coupled, a spot size converter is used for reducing the difference in mode field diameter. Reduction in coupling efficiency is suppressed by increasing the spot size of the optical waveguide to be closer to the mode field diameter of the optical fiber. The mode field diameter of a single-mode fiber (SMF) is small, about 9 μm. Thus, alignment accuracy between the optical fiber core and the optical waveguide is demanding. In view of this, proposed is a configuration of increasing alignment tolerance in the coupling between the SMF and the optical waveguide (see, for example, Patent Document 1).

In the proposed configuration, the end surface of the optical fiber is cut obliquely with respect to the optical axis, the cut face is caused to face a tapered silicon wire waveguide, and the silicon wire waveguide and the optical fiber are optically coupled mainly by directional coupling.

### RELATED ART DOCUMENTS

### Patent Documents

Patent Document 1: Japanese Patent No. 6872329

### SUMMARY OF THE INVENTION

### Problem to be Solved by the Invention

In a publicly known optical coupling configuration, which utilizes directional coupling, the resulting coupling efficiency has a polarization dependency of about 0.7 dB. It is demonstrated to reduce the polarization dependency by controlling the gap between the cut surface of the optical fiber and the silicon wire core. However, controlling the gap raises an issue that the coupling efficiency decreases by about 1 dB. Also, the existing configuration provides a silicon wire sub-waveguide for increasing the coupling efficiency, and thus cannot be used for coupling to a multi-core fiber. Another coupling configuration is the grating coupler. However, because this uses a grating, the wavelength dependency of the coupling efficiency is essentially high, and diffraction to other orders is unavoidable. Therefore, it is challenging to reduce the loss to be 3 dB or lower.

In one aspect, it is an object of the present invention to provide an optical coupling circuit device that has a small polarization dependency of coupling efficiency and is usable for coupling to a multi-core fiber.

### Means for Solving the Problem

In one embodiment, an optical coupling circuit device includes:
an optical circuit board including an optical circuit formed by an optical waveguide;
an optical fiber coupled to the optical circuit board; and
an optical coupling waveguide that is formed in the optical circuit board and configured to optically couple the optical fiber and the optical circuit.

The optical fiber includes a cut surface obliquely cut at an angle of 3° or more and 30° or less with respect to an optical axis of the optical fiber, and is coupled to the optical circuit board at the cut surface.

With a direction normal to the optical circuit board being defined as a z-direction, a plane orthogonal to the z-direction being defined as an xy-plane, a direction in which an optical axis of the optical coupling waveguide extends toward the optical fiber in the xy-plane being defined as an x-direction, and a direction orthogonal to the x-direction and the z-direction being defined as a y-direction, a second position of a leading end of a core end surface exposed at the cut surface is offset from a first position of a coupling end of the optical coupling waveguide in the x-direction and the z-direction.

### Advantageous Effects of the Invention

Provided is an optical coupling circuit device that has a small polarization dependency of coupling efficiency and is usable for coupling to a multi-core fiber.

### BRIEF DESCRIPTION OF THE DRAWINGS

FIG. 1 is a schematic cross-sectional view of an optical coupling circuit device of a first embodiment.

FIG. 2 is a top view and a side view of a spot size conversion optical waveguide.

FIG. 3 is a view of an optical coupling circuit device as viewed in the z-direction.

FIG. 4 is a view illustrating a machining method of a leading end of a holder configured to hold an optical fiber.

FIG. 5 is a schematic cross-sectional view of an optical coupling circuit device of a second embodiment.

FIG. 6 is a schematic cross-sectional view of an optical coupling circuit device of a third embodiment.

FIG. 7 is a view illustrating a machining method of a leading end of a holder configured to hold an optical fiber.

FIG. 8 is a schematic cross-sectional view of an optical coupling circuit device of a fourth embodiment.

FIG. 9 is a view of an optical coupling circuit device as viewed in the z-direction.

FIG. 10 is a view illustrating a machining method of a leading end of a holder configured to hold an optical fiber.

FIG. 11 is a view of an optical coupling circuit device of a fifth embodiment as viewed in the z-direction.

FIG. 12 is a view illustrating a machining method of a leading end of a holder configured to hold an optical fiber.

FIG. 13 is a schematic cross-sectional view of an optical coupling circuit device of a sixth embodiment.

FIG. 14 is a top view and a side view of a spot size conversion optical waveguide.

FIG. 15 is a top view and a side view illustrating another configuration example of a spot size conversion waveguide.

FIG. 16 is a schematic cross-sectional view of an optical coupling circuit device of a seventh embodiment.

FIG. 17 is a top view and a side view of a spot size conversion optical waveguide.

### EMBODIMENTS FOR CARRYING OUT THE INVENTION

In the following, embodiments for carrying out the invention will be described below with reference to the drawings. The embodiments described below are illustrative for embodying the technical concept of the invention, and should not be construed as limiting the present invention to the following configurations and numerical values. In the drawings, members having the same function may be denoted by the same reference numerals, and duplicate description thereof may be omitted. Partial substitution or combination between different embodiments or configuration examples are possible. The size, positional relation, and the like of the members as illustrated in each drawing may be exaggerated for ease of understanding of the invention.

### First Embodiment

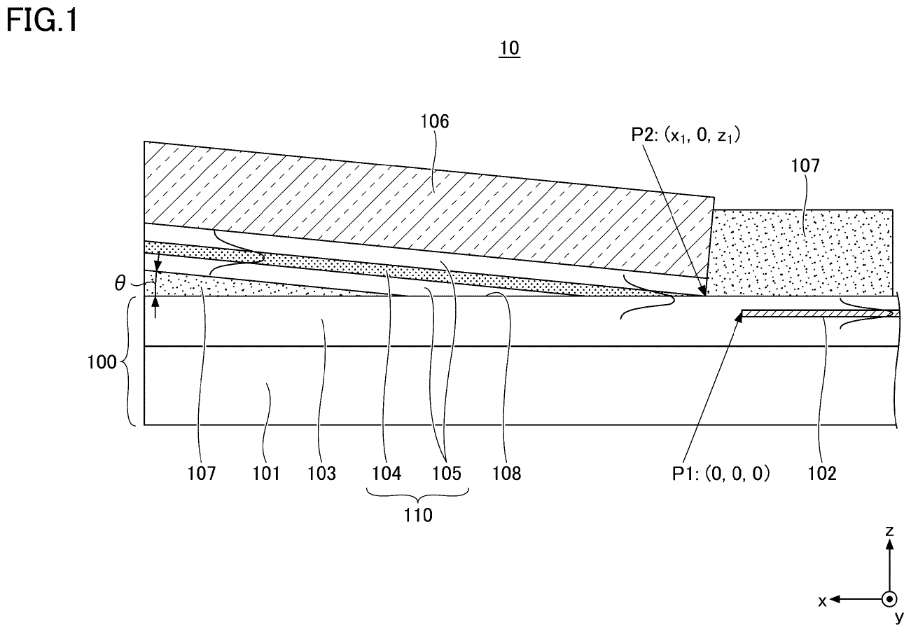

FIG. 1 is a schematic cross-sectional view, along the xz-plane, of an optical coupling circuit device 10 of the first embodiment. The optical coupling circuit device 10 includes an optical circuit board 100, and an optical fiber 110 coupled to the optical circuit board 100. The optical fiber 110 is optically coupled to a spot size conversion optical waveguide 102 formed in the optical circuit board 100. The spot size conversion optical waveguide 102 is an example of the optical coupling waveguide configured to optically couple the optical fiber 110 to a waveguide on the optical circuit board 100.

In the coordinate system as illustrated in FIG. 1, a normal to or thickness direction of the optical circuit board 100 is defined as a +z direction, a direction in which the spot size conversion optical waveguide 102 extends toward the optical fiber 110 in the xy-plane orthogonal to the z-axis (direction extending toward the left-hand side in the drawing sheet) is defined as a +x direction, and a direction orthogonal to the x-direction and the z-direction is defined as the y-direction. The optical axis of the optical coupling circuit device 10 is parallel to the optical axes of the spot size conversion optical waveguide 102 and the optical fiber 110.

An example of the optical circuit board 100 is a silicon wire circuit board. An insulating layer, such as a silicon oxide layer 103 or the like, is formed on a silicon board 101, and the spot size conversion optical waveguide 102 is formed in the silicon oxide layer 103. The spot size conversion optical waveguide 102 is formed of silicon wires, and the silicon oxide layer 103 enclosing the spot size conversion optical waveguide 102 functions as a cladding layer. The spot size conversion optical waveguide 102 is coupled to the optical waveguide, forming the optical circuit, on a side opposite to the side at which the spot size conversion optical waveguide 102 is coupled to the optical fiber 110. The optical circuit includes optical elements, such as an optical modulator, an optical multiplexer, an optical mixer, and the like.

A core 104 of the optical fiber 110 and the spot size conversion optical waveguide 102 are coupled by optical coupling. The optical fiber 110 is, for example, an SMF, and the diameter of the core 104 is about 9 μm. The core 104 is covered by a fiber cladding 105, and the outer diameter of the cladding is from 80 μm through 125 μm. The optical fiber 110 is held by a holder 106 and fixed to the optical circuit board 100 with an adhesive 107 that is transparent to the wavelength in use.

The end surface of the optical fiber 110 is cut obliquely with respect to the optical axis, and the optical fiber 110 is tilted at an angle θ and coupled to the surface of the optical circuit board 100 at a cut surface 108. In order to increase the coupling efficiency between the core 104 of the optical fiber 110 and the spot size conversion optical waveguide 102, a relation of refractive indices is set to n1≥n3≥n2 and n1≥n4≥n2, where n1 denotes a refractive index of the core 104, n2 denotes a refractive index of the fiber cladding 105, n3 denotes a refractive index of the silicon oxide layer 103, and n4 denotes a refractive index of the adhesive 107.

Optimum conditions are neff=n3=n4, where neff denotes an effective refractive index for light propagating through the optical fiber 110 formed of the core 104 and the fiber cladding 105. In principle, a relation of n1≥neff≥n2 is satisfied. The refractive indices are adjustable. For example, generally, the refractive index of the optical fiber 110 is increased by adding germanium or the like to the core 104, or the refractive index of the optical fiber 110 is decreased by adding fluorine to the fiber cladding 105. The refractive index of the silicon oxide layer 103 is variable under vapor deposition/stacking conditions, and can be increased by the addition of germanium.

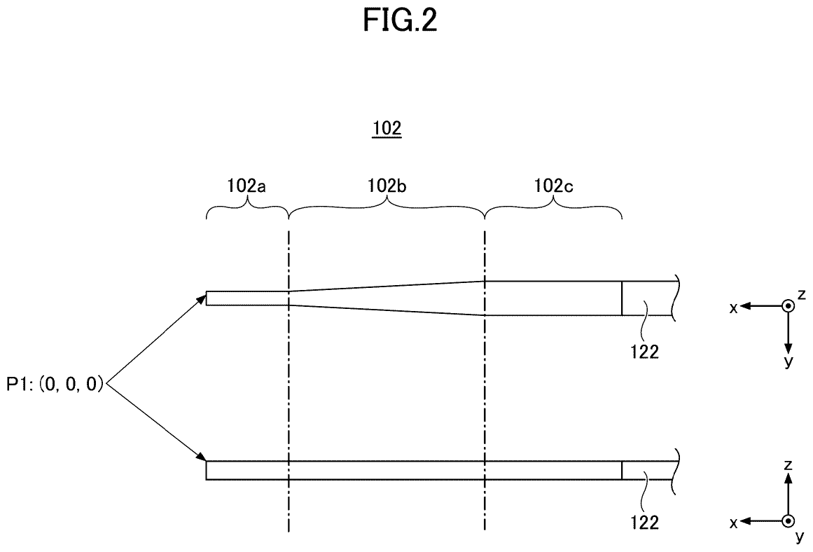

FIG. 2 is a top view and a side view of the spot size conversion optical waveguide 102 formed at the optical circuit board 100. The thickness of the spot size conversion optical waveguide 102 in the z-direction is from 200 nm through 250 nm. In this example, the thickness thereof is 220 nm. The spot size conversion optical waveguide 102 includes a straight waveguide 102a, a tapered waveguide 102b, and a straight waveguide 102c. The straight waveguide 102c is coupled to an optical waveguide 122 coupled to the optical circuit. The width of the straight waveguide 102a is narrower than the width of the straight waveguide 102c. The tapered waveguide 102b is coupled between the straight waveguide 102a and the straight waveguide 102c having different widths.

The straight waveguide 102a is provided on the optical coupling side of the optical fiber 110. Dimensions (length×width×height) of the straight waveguide 102a are 50 μm×150 nm×220 nm. By narrowing the width of the straight waveguide 102a on the leading end side of the spot size conversion optical waveguide 102, the power of light incident on the optical waveguide 122 from the optical fiber 110 can be maintained high.

Dimensions of the tapered waveguide 102b in the yz-plane are 150 nm×220 nm at a portion coupled to the straight waveguide 102a, and are 450 nm×220 nm at a portion coupled to the straight waveguide 102c. The length of the tapered waveguide 102b in the x-direction is 100 μm in this example. Over a length of 100 μm, the width of the tapered waveguide 102b increases smoothly and continuously from 150 nm through 450 nm. Light incident on the tapered waveguide 102b propagates through the optical waveguide 122 while maintaining the current waveguide mode and increasing the mode field diameter.

The straight waveguide 102c serves as a coupling waveguide to the optical waveguide 122 of the optical circuit. Therefore, the straight waveguide 102c has the same dimensions of the yz cross section as the standard dimensions of the yz cross section of the optical waveguide 122 forming the optical circuit. In this example, the dimensions of the yz cross section are 450 nm×220 nm. The spot size conversion optical waveguide 102 is a coupling waveguide between the fiber and the optical waveguide, and can be designed independently of the subsequent optical circuit. Thus, details of the subsequent optical circuit will be omitted.

As illustrated in FIG. 1, P1 denotes a position of a coupling end of the spot size conversion optical waveguide 102 to the optical fiber 110, and P2 denotes a position of a coupling end of the optical fiber 110 the closest to the spot size conversion optical waveguide 102. More specifically, position P1 is a center position at an upper edge of the coupling end of the spot size conversion optical waveguide 102. The position P1 is defined as the origin (0, 0, 0) in an xyz coordinate system. Position P2 of the coupling end of the optical fiber 110 is (x1, 0, z1). As described above, the direction in which the spot size conversion optical waveguide 102 extends toward the optical fiber 110 in the xy-plane is defined as the +x direction, and a height direction of the spot size conversion optical waveguide 102 is defined as the +z direction.

As a feature of the embodiment, an x coordinate value and a z coordinate value of the position P2 with respect to those of the position P1 are x1>0 and z1>0. That is, as the optical coupling circuit device 10 is viewed from the upper surface thereof, the leading end of the core 104 of the optical fiber 110 and the leading end of the spot size conversion optical waveguide 102 do not overlap with each other, and the leading end of the core 104 is offset from the coupling end of the spot size conversion optical waveguide 102 by x1 in the +x direction. As viewed in the yz-plane, the leading end of the core 104 of the optical fiber 110 and the height position of the spot size conversion optical waveguide 102 do not overlap with each other, and the leading end position P2 of the core 104 is offset from the position P1 by z1 in the +z direction.

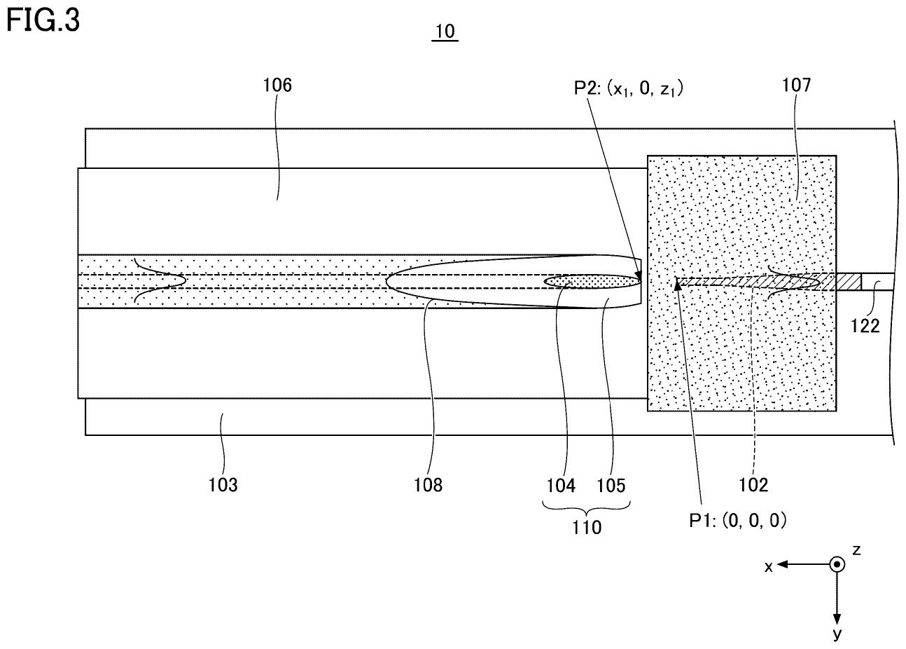

FIG. 3 is a view as viewed from the upper surface of the optical coupling circuit device 10. FIG. 3 illustrates a positional relation of optical coupling, in the xy-plane, between the optical fiber 110 and the spot size conversion optical waveguide 102. The optical fiber 110 is supported on the bottom surface of the holder 106 formed of a transparent board. The holder 106 may be formed of quartz glass that is the same as in the fiber cladding 105. The holder 106 is fixed to the optical circuit board 100 with the adhesive 107, transparent to the wavelength in use, while holding the optical fiber 110. The spot size conversion optical waveguide 102 formed in the optical circuit board 100 is at a position covered by the adhesive 107.

The leading end of the optical fiber 110 is cut obliquely with respect to the center axis of the core 104, and the cut surface 108 of the core 104 has a shape of an ellipse. The cut surface 108 of the entire optical fiber 110 including the core 104 and the fiber cladding 105 has a shape in which a one-side portion along the major axis of the ellipse is cut. In a state in which the holder 106 is fixed to the optical circuit board 100, the position P2 (x1, 0, z1) of the oblique cut surface 108 of the optical fiber 110, i.e., the position at the most leading end, is offset by x1 in the +x direction from the position P1 (0, 0, 0) of the leading end of the spot size conversion optical waveguide 102 in the xy-plane. In the height direction, as described above, the position P2 (x1, 0, z1) is offset from the position P1 by z1 in the +z direction.

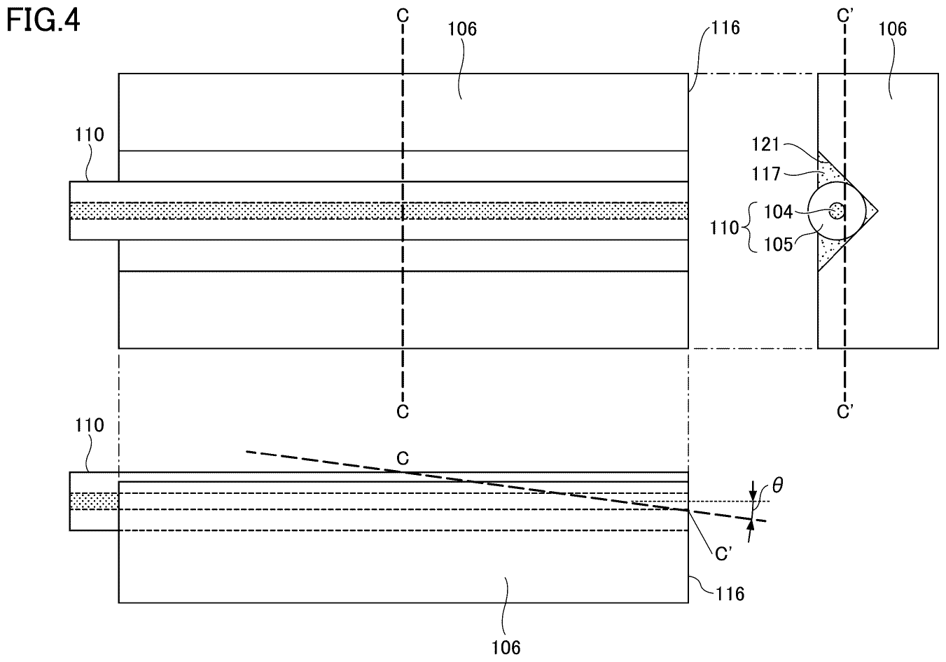

FIG. 4 illustrates a machining method of the leading ends of the optical fiber 110 and the holder 106 holding the optical fiber 110. The center of FIG. 4 is a bottom view of the holder 106 holding the optical fiber 110, the right-hand view thereof is a front view as viewed in the propagation direction, and the lower view thereof is a side view of the holder 106 holding the optical fiber 110. The optical fiber 110 is fixed to a V-shaped groove 121 formed in the holder 106 with an adhesive 117. The adhesive 117 may be the same as or different from the adhesive 107. However, a relation of n1≥ n5≥ n2 is desirable, where n5 denotes a refractive index of the adhesive 117.

In a state in which the optical fiber 110 is adhesively fixed to the V-shaped groove 121 of the holder 106, the optical fiber 110 is obliquely cut along a C-C′ plane from position C toward a leading end surface 116 of the holder 106, followed by polishing. Cutting the optical fiber 110 in this way forms the elliptic cut surface 108 in which the core 104 and the fiber cladding 105 are exposed at the leading end of the optical fiber 110, as illustrated in FIG. 3. The cut surface 108 of the optical fiber 110 is caused to face the surface of the optical circuit board 100. In this state, the leading end of the exposed core 104 is aligned with the position P2, and the holder 106 is fixed to the optical circuit board 100.

The angle @ of the C-C′ cut surface with respect to the optical axis of the optical fiber 110 is set to be in the range of from 3° through 30°. Reducing the angle θ increases the coupling efficiency, but increases the area of the core 104 exposed at the cut surface 108. The angle θ of the C-C′ cut surface is appropriately determined in consideration of coupling efficiency between the optical fiber 110 and the spot size conversion optical waveguide 102 and matching of the mode field diameter.

How the optical coupling circuit device 10 works will be described with reference to FIG. 1. Light propagating through the core 104 of the optical fiber 110 propagates along the optical axis up to the oblique cut surface 108. At the oblique cut surface 108, the propagation direction of light is slightly polarized in the +z direction due to the change in the refractive index. Also, the mode field diameter of the light incident on the silicon oxide layer 103 becomes wider. The propagating light is incident on the spot size conversion optical waveguide 102 from the silicon oxide layer 103, and a part of the light is coupled to the straight waveguide 102a and propagates through the spot size conversion optical waveguide 102. As described above, the light propagating through the spot size conversion optical waveguide 102 maintains the current waveguide mode and is incident on the subsequent optical circuit.

The propagation of the light is reversible. Thus, the light propagating from the optical circuit side to the spot size conversion optical waveguide 102 is also coupled to the core 104 of the optical fiber 110 at the same coupling efficiency, and propagates through the optical fiber 110. According to the configuration of the first embodiment, as the optical fiber 110 and the optical circuit board 100 are coupled at an angle at which they are approximately in parallel, a volume for mounting can be reduced.

The optical coupling between the optical fiber 110 and the spot size conversion optical waveguide 102 does not utilize directional coupling or diffraction grating coupling. Thus, the wavelength dependency and the polarization dependency of the coupling efficiency are reduced.

### Second Embodiment

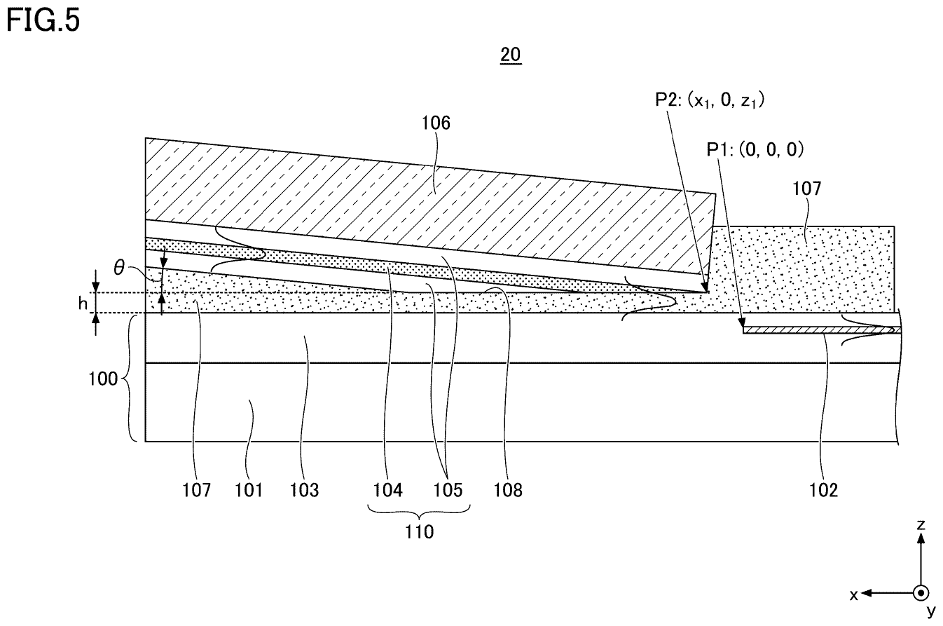

FIG. 5 is a schematic cross-sectional view, along the xz-plane, of an optical coupling circuit device 20 of the second embodiment. Similar to the first embodiment, the optical fiber 110 is optically coupled to the spot size conversion optical waveguide 102 formed at the optical circuit board 100.

In the second embodiment, the oblique cut surface 108 of the optical fiber 110 is positioned at a height h from the surface of the optical circuit board 100. Specifically, a layer of the adhesive 107 exists between the elliptic cut surface 108, in which the core 104 and the fiber cladding 105 are exposed, and the silicon oxide layer 103, and the position of the cut surface 108 is shifted in the +z direction by the thickness of this layer. Similar to the first embodiment, the relation between the refractive index n1 of the core 104, the refractive index n2 of the fiber cladding 105, the refractive index n3 of the silicon oxide layer 103, and the refractive index n4 of the adhesive 107 is n1≥n3≥n2 and n1≥ n4≥ n2. When the effective refractive index, neff, of the entire optical fiber 110 satisfies neff=n3=n4, reflection loss at the coupled portion becomes the minimum.

The configuration of the second embodiment is especially advantageous when the surface of the silicon oxide layer 103 includes irregularities. By providing the layer of the adhesive 107 between the cut surface 108 of the optical fiber 110 and the silicon oxide layer 103, unnecessary reflection can be reduced.

Optical coupling between the core 104 of the optical fiber 110 and the spot size conversion optical waveguide 102 is as described in the first embodiment. When the coordinates of the leading end position P1 of the spot size conversion optical waveguide 102 on the optical coupling side are (0, 0, 0), the coordinates of the position P2 of the core 104 at the cut surface 108 of the optical fiber 110, i.e., the position the closest to the spot size conversion optical waveguide 102, are (x1, 0, z1), with x1>0 and z1>0.

In the second embodiment, the height position of the leading end of the core 104 at the cut surface 108 of the optical fiber 110 is greatly offset in the z-direction by the thickness (height h) of the layer of the adhesive 107 existing between the cut surface 108 and the surface of the optical circuit board 100. Light emitted from the core 104 of the optical fiber 110 passes through the adhesive 107 and the silicon oxide layer 103 while widening the mode field diameter, and is incident on the end surface of the spot size conversion optical waveguide 102. The angle θ at which the optical fiber 110 is mounted in the optical circuit board 100 may be adjusted in the range of from 3° through 30° so as to achieve the maximum coupling efficiency. Alternatively, the value x1 of the x-coordinate of the position P2 may be adjusted so as to achieve the maximum coupling efficiency. Thereby, light loss due to mode mismatch can be suppressed, and the power incident on the spot size conversion optical waveguide 102 can be maintained to be high.

### Third Embodiment

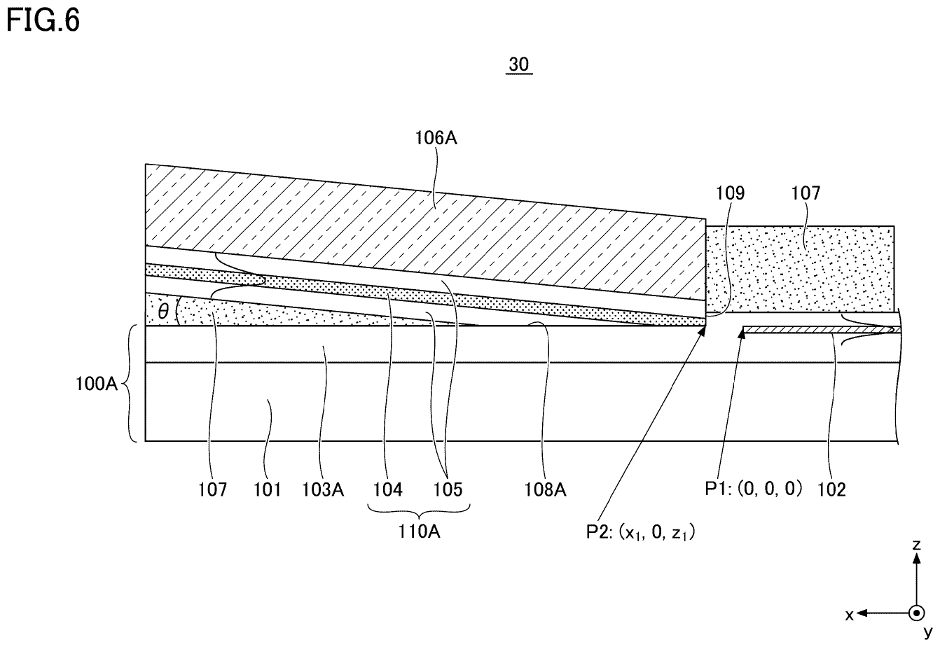

FIG. 6 is a schematic cross-sectional view, along the xz-plane, of an optical coupling circuit device 30 of the third embodiment. The optical coupling circuit device 30 includes an optical circuit board 100A, and an optical fiber 110A coupled to the optical circuit board 100A. The optical fiber 110A is optically coupled to the spot size conversion optical waveguide 102 formed in the optical circuit board 100A in the xz-plane.

In the third embodiment, the shapes of the leading end of the optical fiber 110A and the leading end of a holder 106A holding the optical fiber 110A are changed, and a step 109 is provided at the silicon oxide layer 103 on the surface of the optical circuit board 100A. Compared to the first embodiment and the second embodiment, the mode field diameter at the cut surface 108A at the leading end of the optical fiber 110A is reduced. More specifically, the most leading end portion of the obliquely cut optical fiber 110A and the holder 106A is further cut off, thereby making the mode field diameter of the optical fiber 110A closer to the mode field diameter of the spot size conversion optical waveguide 102. This increases the coupling efficiency.

The holder 106A is fixed to the optical circuit board 100A with the adhesive 107 in a state in which the end surfaces of the optical fiber 110A and the holder 106A are contacted with the step 109 of the silicon oxide layer 103. By contacting the end surface of the holder 106A with the step 109, the position P2 of the leading end of the core 104 is self-aligned with the position P1 of the coupling end of the spot size conversion optical waveguide 102. This contact structure facilitates positional adjustment and fixation of the holder 106A and the optical fiber 110.

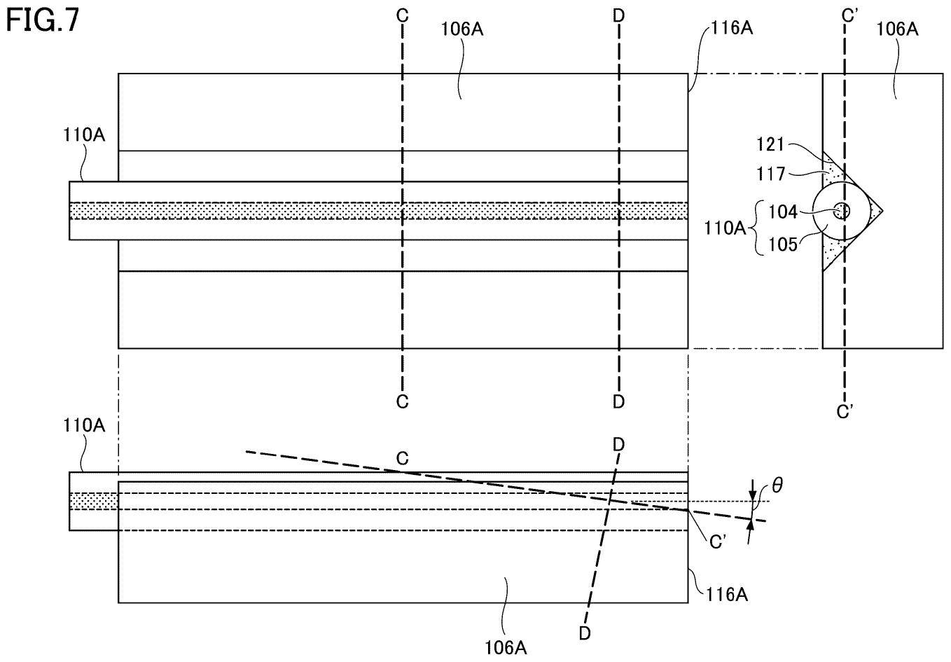

FIG. 7 illustrates a machining method of the leading ends of the optical fiber 110A and the holder 106A holding the optical fiber 110A. The center of FIG. 7 is a bottom view of the holder 106A holding the optical fiber 110A, the right-hand side of the drawing sheet is a front view as viewed in the propagation direction, and the lower side of the drawing sheet is a side view of the holder 106A holding the optical fiber 110A. The optical fiber 110 is fixed to the V-shaped groove 121 formed in the holder 106 with the adhesive 117. The adhesive 117 may be the same as or different from the adhesive 107. However, a relation of n1≥ n5≥ n2 is desirable, where n5 denotes a refractive index of the adhesive 117.

In a state in which the optical fiber 110A is adhesively fixed to the V-shaped groove 121 of the holder 106A, the optical fiber 110A is obliquely cut along the C-C′ plane from the position C toward position C′ of the leading end surface 116A of the holder 106A, followed by polishing. Subsequently, the leading end of the holder 106A is cut along a D-D′ plane at a position slightly receding from the leading end surface 116A, followed by polishing. The C-C′ plane and the D-D′ plane form an approximately right angle. The approximately right angle does not refer to an angle of exactly 90°, but includes a range of from 80° through 100° including an allowable range of manufacturing error. Thereby, the oblique cut surface 108 of the optical fiber 110A is aligned with the surface of the optical circuit board 100A, and the leading end of the holder 106A (i.e., the D-D′ plane) can be contacted with the step 109.

In addition to reducing wavelength dependency and polarization dependency of the coupling efficiency, the configuration of the optical coupling circuit device 30 of the third embodiment can make the mode field diameters of the optical fiber 110A and the spot size conversion optical waveguide 102 be closer to each other. Thus, the coupling efficiency can be further increased.

### Fourth Embodiment

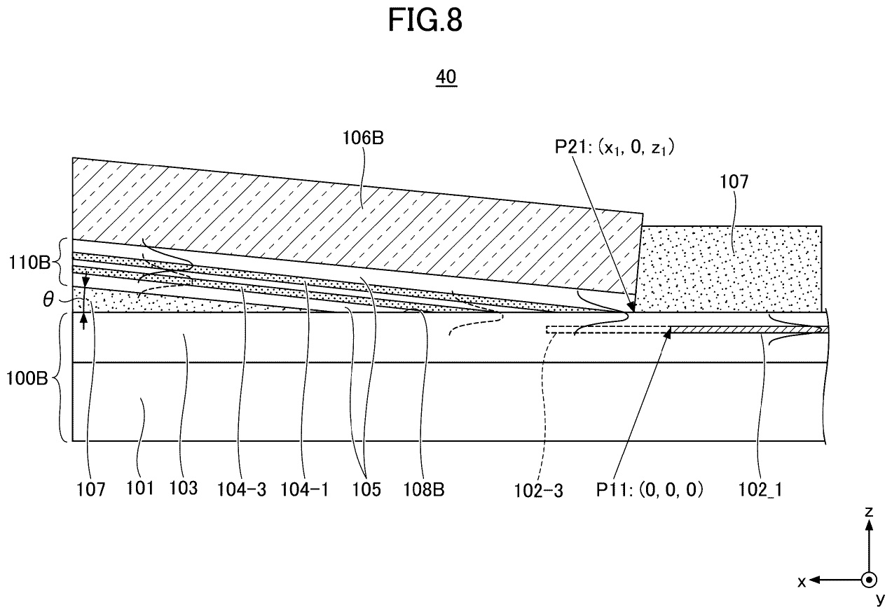

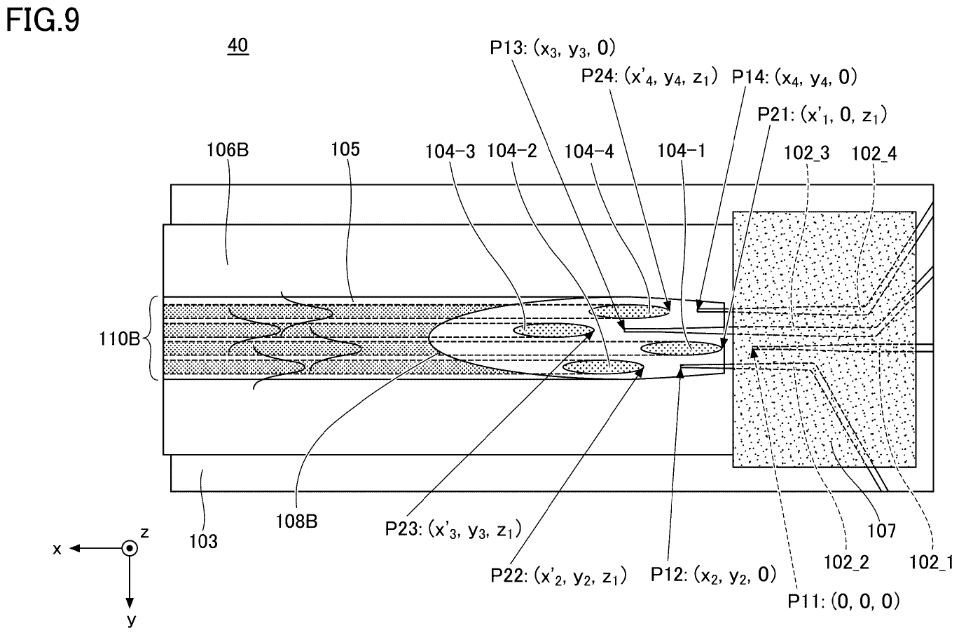

FIG. 8 is a schematic cross-sectional view, along the xz-plane, of the optical coupling circuit device 40 of the fourth embodiment. FIG. 9 is a schematic view of the optical coupling circuit device 40 as viewed from the upper surface thereof, i.e., in the z-direction. The optical coupling circuit device 40 includes an optical circuit board 100B, and an optical fiber 110B coupled to the optical circuit board 100B. In the fourth embodiment, as the optical fiber 110B, a multi-core fiber having multiple cores is held by a holder 106B and coupled to the optical circuit board 100B.

As illustrated in FIG. 9, the optical fiber 110B includes, for example, four cores 104_1, 104_2, 104_3, and 104_4 (hereinafter may be collectively referred to as the “core 104” as appropriate). The leading end of the optical fiber 110B is cut obliquely with respect to the optical axis, and the end surfaces of the four cores 104 are exposed at the cut surface 108B.

Four spot size conversion optical waveguides 102_1, 102_2, 102_3, and 102_4 (hereinafter may be collectively referred to as the “spot size conversion optical waveguide 102” as appropriate) are formed at the optical circuit board 100B. Each of the four cores 104 of the optical fiber 110B is coupled to a corresponding spot size conversion optical waveguide 102.

The spot size conversion optical waveguides 102_1, 102_2, 102_3, and 102_4 extend in a direction in which the distance therebetween becomes wider so as to avoid crosstalk. The coupling ends of the spot size conversion optical waveguides 102_1, 102_2, 102_3, and 102_4 extend to the vicinity of the cores 104_1, 104_2, 104_3, and 104_4 exposed at the cut surface 108B.

The coordinates of position P11 of the coupling end of the spot size conversion optical waveguide 102_1 are (0, 0, 0). The coordinates of position P12 of the coupling end of the spot size conversion optical waveguide 102_2 are (x2, y2, 0). The coordinates of position P13 of the coupling end of the spot size conversion optical waveguide 102_3 are (x3, y3, 0). The coordinates of position P14 of the coupling end of the spot size conversion optical waveguide 102_4 are (x4, y4, 0).

The coordinates of position P21 of the leading end of the core 104_1 exposed at the cut surface 108A of the optical fiber 110B are (x1, 0, z1). The coordinates of position P22 of the leading end of the core 104_2 are (x2′, y2, z1). The coordinates of position P23 of the leading end of the core 104_3 are (x3′, 0, z1). The coordinates of position P24 of the leading end of the core 104_4 are (x4′, 0, z1). The positions P21 to 24 of the leading ends of the four cores 102 are in the same xy-plane.

The values of the y coordinates of the positions P21, 22, 23, and 24 are the same as the values of the y coordinates of the positions P11, P12, P13, and P14 of the coupling ends of the corresponding spot size conversion optical waveguides 102. That is, the core 104 is positioned in the same xz-plane as is the corresponding spot size conversion optical waveguide 102, but is offset in the x- and z-directions from the position of the coupling end of the spot size conversion optical waveguide 102. This is generalized as follows. Specifically, when the coordinates of the coupling end of the k^{th} spot size conversion optical waveguide 102_k are (xk, yk, 0), the coordinates of the leading end position of the k^{th} core are (xk′, yk′, z1), with xk′>xk, yk′=yk, and z1>0.

As illustrated in FIG. 8, light propagating through the core 104_1 is slightly polarized in the +z direction at the cut surface 108B, and travels in the silicon oxide layer 103 and is incident on the corresponding spot size conversion optical waveguide 102_1 at the position P11. Light propagating through the core 104_3 is slightly polarized in the +z direction at the cut surface 108B, and travels in the silicon oxide layer 103 and is incident on the corresponding spot size conversion optical waveguide 102_3. Similarly, light propagating through the other cores 104_2 and 104_4 is slightly polarized in the +z direction at the interface with the silicon oxide layer 103 and is incident on the corresponding spot size conversion optical waveguides 102_2 and 102_4.

With the configurations as illustrated in FIG. 8 and FIG. 9, when a multi-core fiber is used, each of the cores 104 can be optically coupled to the corresponding spot size conversion optical waveguide 102 on the optical circuit board 100B.

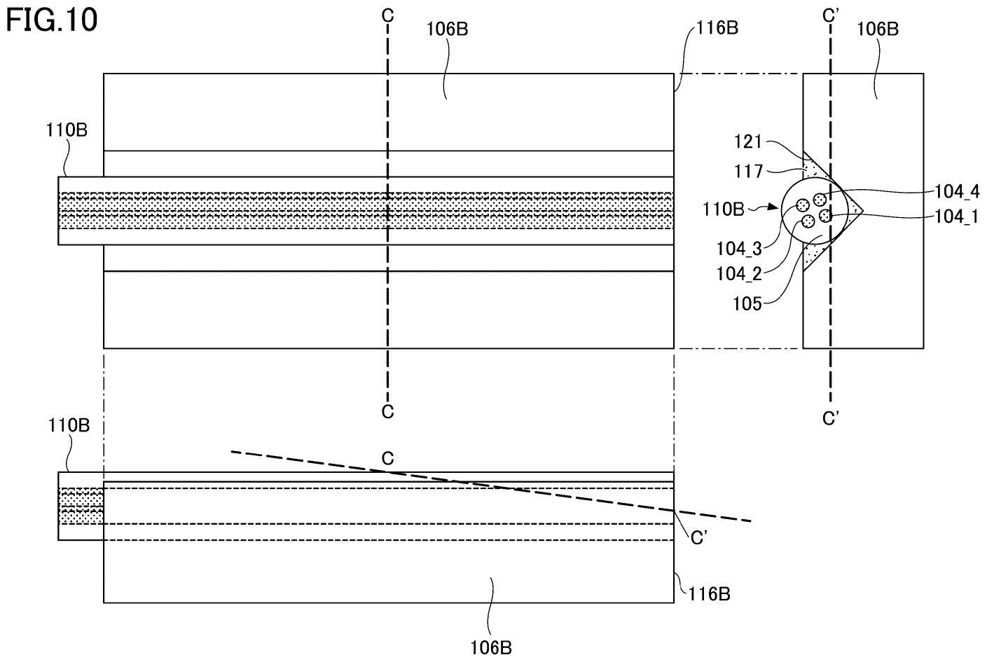

FIG. 10 illustrates a machining method of the leading ends of the optical fiber 110B and the holder 106B holding the optical fiber 110B. The center of FIG. 10 is a bottom view of the holder 106B holding the optical fiber 110B, the right-hand side of the drawing sheet is a front view as viewed in the propagation direction, and the lower side of the drawing sheet is a side view of the holder 106B holding the optical fiber 110B. The optical fiber 110B is fixed to the V-shaped groove 121 formed in the holder 106B with the adhesive 117. The adhesive 117 may be the same as or different from the adhesive 107. However, a relation of n1≥ n5≥ n2 is desirable, where n5 denotes a refractive index of the adhesive 117.

In a state in which the optical fiber 110B is adhesively fixed to the V-shaped groove 121 of the holder 106B, the optical fiber 110B is obliquely cut along a C-C′ plane from position C toward position C′ of a leading end surface 116B of the holder 106A, followed by polishing. Cutting the optical fiber 110B in this way forms an elliptic cut surface 108B in which four cores 104 are exposed at the leading end of the optical fiber 110B, as illustrated in FIG. 8. The cut surface 108B of the optical fiber 110B is caused to face the surface of the optical circuit board 100B. In this state, the holder 106B is fixed to the optical circuit board 100B such that the leading ends of the exposed cores 104_1, 104_2, 104_3, and 104_4 are positioned at positions P21, 22, 23, and 24.

Upon fixing the optical fiber 110B to the holder 106B, the optical fiber 110B is rotated with respect to the center axis of the fiber. Thereby, the x and y coordinates of the leading end positions of the fiber cores at the cut surface 108B can be separated between the cores 104 to the extent possible. This can suppress crosstalk.

### Fifth Embodiment

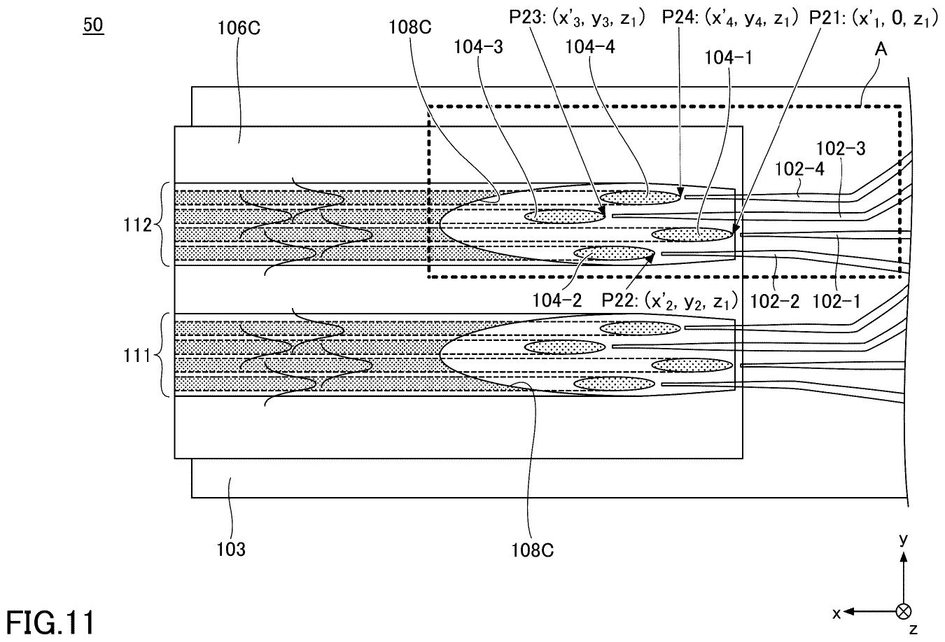

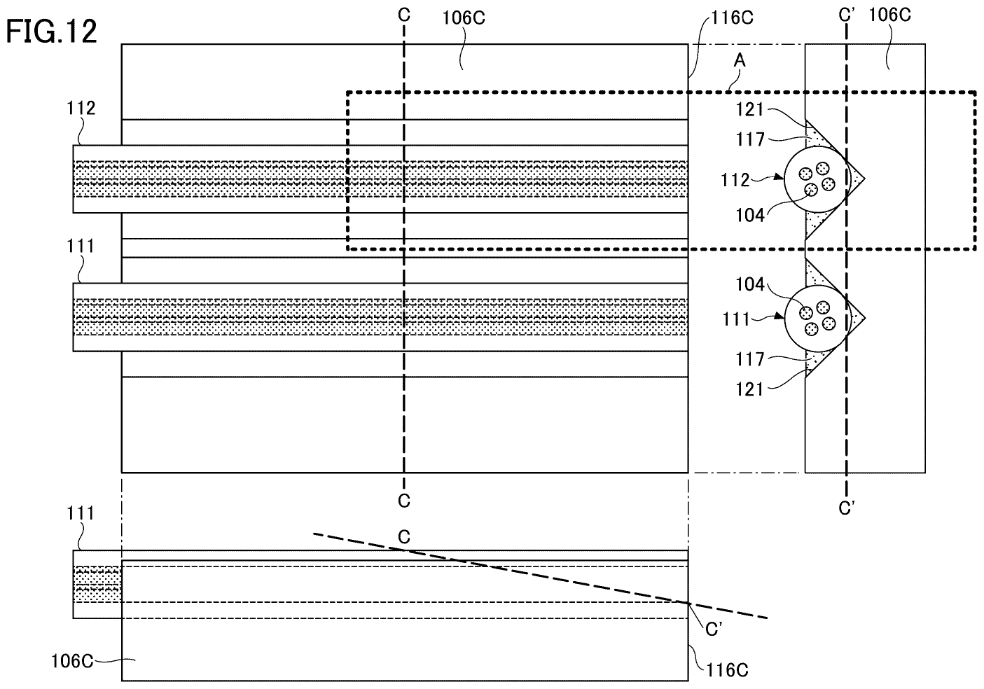

FIG. 11 is a schematic view of an optical coupling circuit device 50 of the fifth embodiment as viewed from the upper surface thereof, i.e., as viewed in the z-direction. FIG. 12 illustrates a machining method of a leading end of a holder 106C configured to hold multi-core fibers 111 and 112. The optical coupling circuit device 50 has the same basic structure as that of the optical coupling circuit device 40 of the fourth embodiment, except that two multi-core fibers 111 and 112 are held on the holder 106C.

In the example of FIG. 11, each of the multi-core fibers 111 and 112 includes four cores. A coupling state of region A enclosed by a dotted line is the same as the coupling state as illustrated in FIG. 9, which illustrates the fourth embodiment. Elliptic core end surfaces of the cores 104_1, 104_2, 104_3, and 104_4 are exposed at a cut surface 118C of the leading end of the multi-core fiber 112. The x coordinates of the leading end positions P21, P22, P23, and P24 at each core end surface are offset in the +x direction from the positions of the coupling ends of the corresponding spot size conversion optical waveguides 102_1, 102_2, 102_3, and 102_4. In the case of the multi-core fiber 111, the coupling states of the four cores are the same as those in the region A, except that the y-coordinate positions are different.

For each of the multi-core fibers 111 and 112, when the coordinates of the coupling end of the k^{th} spot size conversion optical waveguide 102_k are (xk, yk, 0), the coordinates of the leading end position of the k^{th} core are (xk′, yk′, z1), with xk′>xk, yk′=yk, and z1>0.

As illustrated in FIG. 12, the multi-core fibers 111 and 112 are adhesively fixed with the adhesive 117 to two V-shaped grooves 121 formed in the holder 106C. The multi-core fibers 111 and 112 form a fiber array. In a state in which the multi-core fibers 111 and 112 are adhesively fixed, the multi-core fibers 111 and 112 are obliquely cut along a C-C′ plane from position C toward position C′ at a leading end surface 116C of the holder 106C, followed by polishing.

Cutting the multi-core fibers 111 and 112 in this way forms an elliptic cut surface 108C in which the four cores 104 are exposed at each of the multi-core fibers 111 and 112, as illustrated in the region A of FIG. 11. The cut surfaces 108C of the multi-core fibers 111 and 112 are caused to face the surface of the silicon oxide layer 103 of the optical circuit board 100. The holder 106C is fixed to the optical circuit board so that the leading end positions of the core end surfaces the closest to the spot size conversion optical waveguides 102 are at positions P21, 22, 23, and 24.

Upon fixing the multi-core fibers 111 and 112 to the holder 106C, each of the multi-core fibers 111 and 112 is rotated with respect to the center axis of the fiber. Thereby, the x and y coordinates of the leading end positions of the fiber cores at each of the cut surfaces 108C can be separated between the cores 104 to the extent possible. This can suppress crosstalk.

### Sixth Embodiment

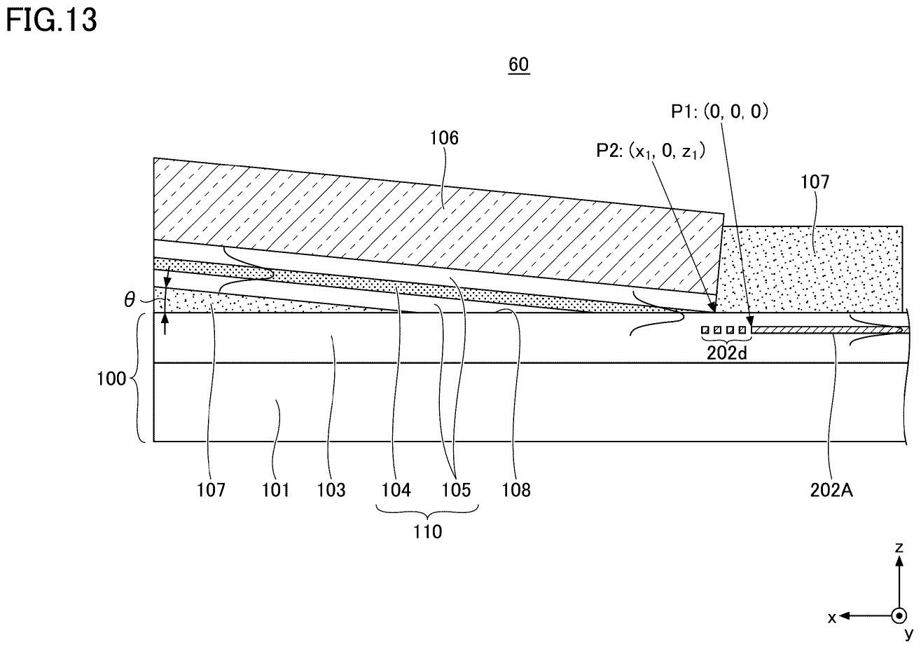

FIG. 13 is a schematic cross-sectional view, along the xz-plane, of an optical coupling circuit device 60 of the sixth embodiment. The optical coupling circuit device 60 includes a spot size conversion optical waveguide 202A formed at the optical circuit board 100. The spot size conversion optical waveguide 202A includes an islet-shaped waveguide region 202d on the +x side (x>0) of the position P1. Similar to the first to fifth embodiments, the coupling end of the spot size conversion optical waveguide 202A is an end of a waveguide portion continuously extending in the x-direction, and is an end surface including the position P1 (0, 0, 0). This coupling end is offset in the x and z directions from the position P2 of the leading end of the optical fiber 110.

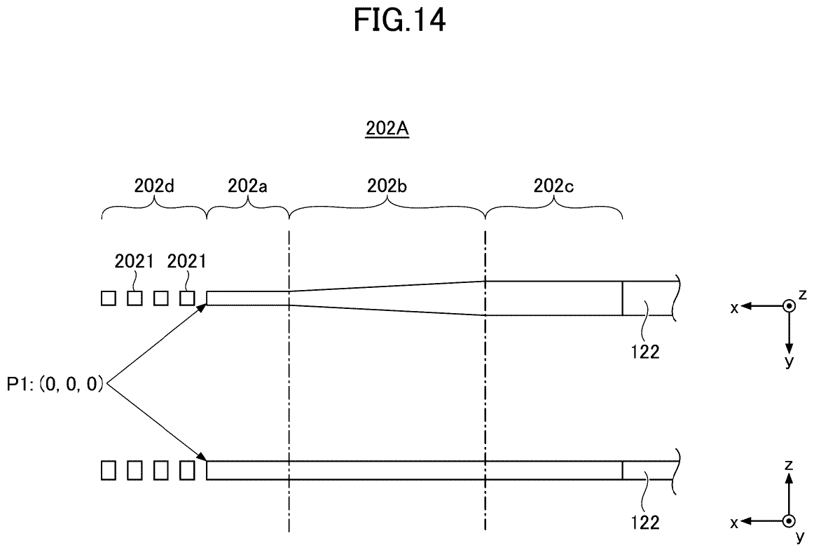

FIG. 14 is a top view and a side view of the spot size conversion optical waveguide 202A. The spot size conversion optical waveguide 202A includes a straight waveguide 202c, coupled to the optical waveguide 122 of the optical circuit, a tapered waveguide 202b, a straight waveguide 202a, and the islet-shaped waveguide region 202d. The regions of the spot size conversion optical waveguide 202A are formed of the same material, e.g., an Si waveguide. By the presence of the tapered waveguide 202b, the width of the straight waveguide 202a is narrower than the width of the straight waveguide 202c. The islet-shaped waveguide region 202d is formed on the +x side of the position P1 of the end of the straight waveguide 202a.

The islet-shaped waveguide region 202d includes multiple islets 2021 arranged in a row. The size of each of the islets 2021 in the xy-plane is equal to or less than 250 nm×250 nm, and the distance between the edges of the islets 2021 is 500 nm or less. Although the shape of the islets 2021 in the xy-plane is rectangular in FIG. 14, the shape of the islets 2021 may be any shape, such as a circle, an ellipse, or a polygon, as long as the sizes and the intervals of the islets 2021 are within the above range.

As illustrated in FIG. 13, the islet-shaped waveguide region 202d extends to the vicinity of the x coordinate of the position P2 at the leading end of the optical fiber 110, and widens the field distribution of light. Thereby, the difference from the field distribution of the optical fiber 110 can be reduced to increase the coupling efficiency and control the polarization dependency. By changing the width of the islet 2021 in the y-direction, the field distribution mainly in the y-direction can be changed. Also, by changing the width of the islet 2021 in the x-direction, the field distribution mainly in the z-direction can be changed. That is, this leads to a change in the coupling efficiency to TE light and TM light propagating through the optical waveguide 122 when the fiber-propagating light is coupled to the optical waveguide 122 of the optical circuit.

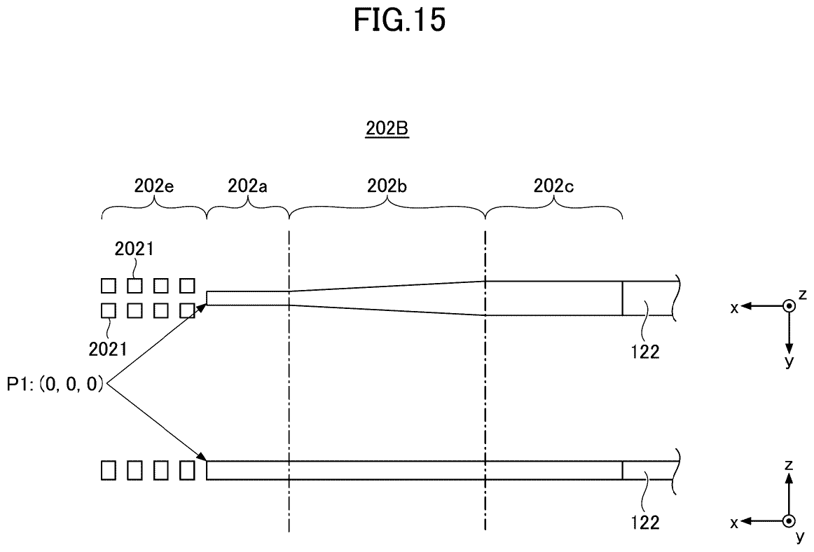

FIG. 15 is a top view and a side view of a spot size conversion waveguide 202B in another configuration example. The spot size conversion waveguide 202B includes a straight waveguide 202c, coupled to the optical waveguide 122 of the optical circuit, a tapered waveguide 202b, a straight waveguide 202a, and an islet-shaped waveguide region 202e. In the islet-shaped waveguide region 202e, multiple islets 2021 are arranged in two rows. The size of each islet 2021 in the xy-plane is equal to or less than 250 nm×250 nm, and the distance between the edges of the islets 2021 is 500 nm or less. By arranging the islets 2021 in two rows, the field distribution in the y-direction can be further widened. Although FIG. 14 and FIG. 15 illustrate examples in which the islets are arranged in one or two rows, various arrangements are possible as long as the size of each islet 2021 in the xy-plane is equal to or less than 250 nm×250 nm, and the distance between the edges of the islets 2021 is 500 nm or less.

### Seventh Embodiment

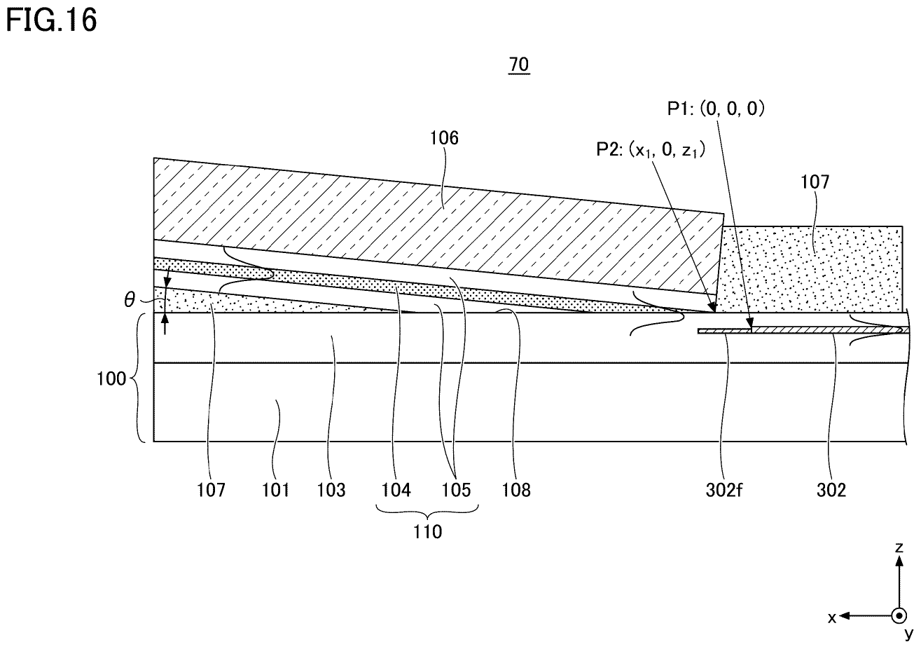

FIG. 16 is a schematic cross-sectional view, along the xz-plane, of the optical coupling circuit device 70 of the seventh embodiment. The optical coupling circuit device 70 includes a spot size conversion optical waveguide 302 formed at the optical circuit board 100. The spot size conversion optical waveguide 302 includes a waveguide region 302f on the +x side (x>0) of the position P1, the waveguide region 302f being lower in height. The coupling end of the spot size conversion optical waveguide 302 is an end of a waveguide portion extending in the x-direction at the same height, and is an end surface including the position P1 (0, 0, 0). This coupling end is offset in the x and z directions from the position P2 of the leading end of the optical fiber 110.

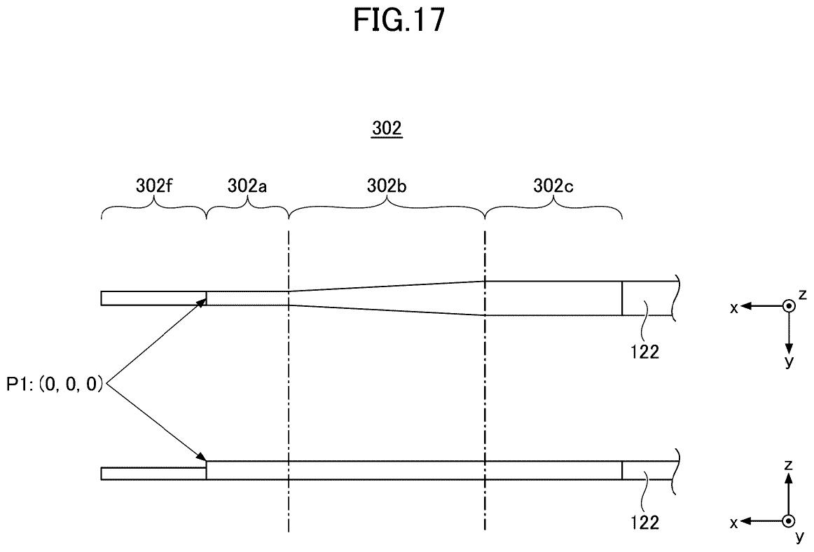

FIG. 17 is a top view and a side view of the spot size conversion optical waveguide 302. The spot size conversion optical waveguide 302 includes a straight waveguide 302c, coupled to the optical waveguide 122 of the optical circuit, a tapered waveguide 302b, a straight waveguide 302a, and a waveguide region 302f that is lower in height than the other regions of the spot size conversion optical waveguide 302. The regions of the spot size conversion optical waveguide 302 are formed of the same material, for example, an Si waveguide. By the presence of the tapered waveguide 202b, the width of the straight waveguide 202a is narrower than the width of the straight waveguide 202c. However, the heights of these waveguide regions are the same. The width of the waveguide region 302f, which is lower in height, is the same as the width of the straight waveguide 302a. However, the height of the waveguide region 302f is lower than the height of the straight waveguide 302a. By reducing the height in the region extending to the +x side of the position P1, the field distribution of light mainly in the z-direction is widened, and the difference from the field distribution of the optical fiber 110 is reduced, thereby increasing the coupling efficiency. Also, a change in the field distribution leads to a change in the coupling efficiency to TE light and TM light propagating through the optical waveguide 122 when the fiber-propagating light is coupled to the optical waveguide 122. This can control polarization dependency.

In FIG. 17, the height of the waveguide region 302f is lowered in a stepwise manner. However, the waveguide region 302f may be tilted from the end of the straight waveguide 302a, and continuously lowered in height.

Although the present invention has been described above based on the specific embodiments, the present invention is not limited to the above-described configuration examples, which include various changes, substitutions, and combinations. The configurations of the first to seventh embodiments can be combined with each other. For example, the configuration of the fifth embodiment, in which the multiple multi-core fibers form the fiber array, may be applied to a configuration in which multiple SMFs form a fiber array. The configurations of the spot size conversion optical waveguides in the sixth and seventh embodiments are applicable to the second to fifth embodiments. In the third to fifth embodiments, the layer of the adhesive 107 may be interposed between the oblique cut surface 108 and the silicon oxide layer 103. The number of the cores of the multi-core fiber is not limited to four, and may be two or three.

In any of the configurations, the fiber and the optical circuit board are coupled at a small angle, e.g., from 3° through 30°, and thus the volume for mounting can be reduced. In any configuration, the light emitted from the optical fiber is coupled to an optical waveguide, such as a silicon wire waveguide, without utilizing directional coupling or diffraction grating coupling. Thereby, it is possible to reduce the polarization dependency and the wavelength dependency of the coupling efficiency. Further, although optical coupling of a multi-core fiber is challenging in a publicly known configuration, the multi-core fiber can be optically coupled to the spot size conversion optical waveguide by employing the optical coupling configuration of the embodiment.

By adjusting the refractive indices of the core 104 of the optical fiber, the fiber cladding 105, the silicon oxide layer 103 on the optical circuit board, and the adhesive 107, highly efficient optical coupling is possible. In the case of employing a configuration in which the adhesive covers the surface irregularities of the optical circuit board 100, reduction in coupling efficiency can be suppressed by reducing unnecessary reflection. Any coupling configuration is readily assembled, and this can reduce the production cost.

The optical coupling circuit device of the embodiment is utilized to couple an optical fiber to an optical waveguide on an optical circuit board in silicon photonics products that are used in in-vehicle optical networks and other various optical networks.

This application claims priority to Japanese Patent Application No. 2021-199560 filed on Dec. 8, 2021, and the entire contents of this Japanese patent application are incorporated herein by reference.

### REFERENCE SIGNS LIST

10, 20, 30, 40, 50, 60, 70 Optical coupling circuit device
100, 100A, 100B Optical circuit board
101 Silicon board
102, 102_1, 102_2, 102_3, 102_4, 202A, 202B, 302
   Spot size conversion
   optical waveguide
   (optical coupling waveguide)
102a, 102c, 202a, 202c, 302a, 302c Straight waveguide
102b, 202b, 302b Tapered waveguide
103 Silicon oxide layer
   (waveguide cladding)
104, 104_1, 104_2, 104_3, 104_4 Core
105 Fiber cladding
106, 106A, 106B, 106C Holder
107, 117 Adhesive
108, 108A, 108B, 108C Cut surface
110, 110A, 110B Optical fiber
111, 112 Multi-core fiber
116, 116A, 116B, 116C Leading end surface
202d, 202e Islet-shaped waveguide region
302f Waveguide region
2021 Islet

1. An optical coupling circuit device, comprising:
an optical circuit board including an optical circuit formed by an optical waveguide;
an optical fiber coupled to the optical circuit board; and
an optical coupling waveguide that is formed in the optical circuit board and configured to optically couple the optical fiber and the optical circuit, wherein
the optical fiber includes a cut surface obliquely cut at an angle of 3° or more and 30° or less with respect to an optical axis of the optical fiber, and is coupled to the optical circuit board at the cut surface, and
with a direction normal to the optical circuit board being defined as a z-direction, a plane orthogonal to the z-direction being defined as an xy-plane, a direction in which an optical axis of the optical coupling waveguide extends toward the optical fiber in the xy-plane being defined as an x-direction, and a direction orthogonal to the x-direction and the z-direction being defined as a y-direction, a second position of a leading end of a core end surface exposed at the cut surface is offset from a first position of a coupling end of the optical coupling waveguide in the x-direction and the z-direction.

2. The optical coupling circuit device according to claim 1, wherein
the optical axis of the optical fiber is in an xz-plane, and
x1>0 and z1>0, where
coordinates of the first position are (0, 0, 0), and
coordinates of the second position are (x1, 0, z1).

3. The optical coupling circuit device according to claim 1, further comprising:
a holder configured to hold the optical fiber, wherein
the holder includes a leading end surface that is cut so as to be approximately orthogonal to the cut surface of the optical fiber.

4. The optical coupling circuit device according to claim 3, wherein
a step is provided at a surface of the optical circuit board, and
the leading end surface of the holder is contacted with the step.

5. The optical coupling circuit device according to claim 1, wherein
the optical fiber is a single-mode fiber.

6. The optical coupling circuit device according to claim 1, wherein
the optical fiber is a multi-core fiber including an m number of cores, where m is an integer of 2 or more,
an m number of optical coupling waveguides are formed in the optical circuit board, the optical coupling waveguides each being the optical coupling waveguide, and
xk′>xk, yk′=yk, and z1>0, where
coordinates of the coupling end of a k^{th} optical coupling waveguide are (xk, yk, 0), and
coordinates of a leading end position of a k^{th} core are (xk′, yk′, z1).

7. The optical coupling circuit device according to claim 1, further comprising:
a fiber array formed of multiple optical fibers each being the optical fiber.

8. The optical coupling circuit device according to claim 1, wherein
the optical coupling waveguide is covered by a waveguide cladding,
the cut surface of the optical fiber is fixed to the optical circuit board with an adhesive that is transparent to a wavelength in use, and
n1≥n3≥ n2 and n1≥n4≥n2, where
n1 denotes a refractive index of a core of the optical fiber,
n2 denotes a refractive index of a fiber cladding,
n3 denotes a refractive index of the waveguide cladding, and
n4 denotes a refractive index of the adhesive.

9. The optical coupling circuit device according to claim 1, wherein
the optical coupling waveguide includes
an islet-shaped waveguide region extending from the first position in a +x direction.

10. The optical coupling circuit device according to claim 1, wherein
the optical coupling waveguide includes
a waveguide region extending from the first position in a +x direction and being lower in height than other regions of the optical coupling waveguide.
